(19) United States
(12) Patent Application Publication
(10) Pub. No.: US 2017/0164773 A1
(43) Pub. Date: Jun. 15, 2017

(54) Electronic Mailbox System

(71) Applicant: Mark Wirtz, Overland Park, KS (US)

(72) Inventor: Mark Wirtz, Overland Park, KS (US)

(21) Appl. No.: 15/375,413

(22) Filed: Dec. 12, 2016

Related U.S. Application Data
(60) Provisional application No. 62/265,492, filed on Dec. 10, 2015.

(51) Int. Cl. A47G 29/122; G07C 9/00; G08B 21/18; A47G 29/14; A47G 29/124

(52) U.S. Cl. CPC A47G 29/1214; A47G 29/141; A47G 29/1225; A47G 29/124; G08B 21/18; G07C 9/00174; A47G 2029/147; A47G 2029/1226

(57) ABSTRACT

An electronic mailbox system. The electronic mailbox system provides for securely receiving mail and packages, and notifying a user of attempts to access the received mail. The electronic mailbox system includes a housing for storing packages and a door connected to the housing that can be opened and closed. A locking mechanism is operably connected to the door and configured to control access to packages within the housing. A sensor can detect motion of the door and send a notification to an electronic device of the opening and closing of the door. Further, a refrigeration unit can be activated to cool the interior of the housing. In one embodiment, the electronic device can cause the actuation of the locking an mechanism to unlock or lock the door and can control the refrigeration unit to regulate a temperature of the interior of the housing.

### CROSS REFERENCE TO RELATED APPLICATION

This application claims the benefit of U.S. Provisional Application No. 62/265,492 filed on Dec. 10, 2015. The above identified patent application is herein incorporated by reference in its entirety to provide continuity of disclosure.

### BACKGROUND OF THE INVENTION

### Field of the Invention

The present invention relates to an electronic mailbox system. More specifically, the present invention provides a mailbox housing with an interior volume configured to hold mail, a refrigeration unit for maintaining a cool temperature within the mailbox housing, a locking mechanism for a door, a motion sensor for detecting whether the door is in an open configuration or a closed configuration, and a transceiver for sending information related to the configuration of the door to a remote electronic device.

Mail and other packages are delivered to homes and business throughout the day by carriers, such as the United States Postal Service. Typically, mail is dropped off in mailboxes or left in close proximity to a recipient's door regardless if the recipient is physically present at that location. If the package is too large for the mailbox or if the limited space of the mailbox is occupied, the package must be stored elsewhere or the carrier leaves a drop-off note that requires the recipient to retrieve the package at a designated location.

If the carrier delivers the package when the recipient is unavailable, the recipient does not become aware of the arrived package until the recipient opens the mailbox and physically retrieves the package. Often, there is significant time between the delivery and retrieval whereupon a thief can take or tamper with another person's mail.

Devices have been disclosed in the known art that relate to mail package delivery systems. These include systems that have been patented and published in patent application publications. However, these devices have several known drawbacks. For example, some carriers utilize a tracking and notification system that alerts a recipient of the delivery of a package. But, the package can subsequently be removed from the mailbox without the authorization from the recipient.

In light of the devices disclosed in the known art, it is submitted that the present invention substantially diverges in design elements from the known art and consequently it is clear that there is a need in the art for an improvement to existing electronic mailbox systems. In this regard the instant invention substantially fulfills these needs.

### SUMMARY OF THE INVENTION

In view of the foregoing disadvantages inherent in the known types of mailbox systems now present in the prior art, the present invention provides a new electronic mailbox system wherein the same can be utilized for providing convenience for the user when the user receives mail at a time when the user is away from the mailbox.

It is therefore an object of the present invention to provide a new and improved electronic mailbox system comprising a mailbox housing configured to receive mail and packages, and a locking mechanism for a door that allows the user to control access to the interior of the housing.

It is another object of the present invent on to provide an electronic mailbox system that determines the opening and closing of the mailbox door via a motion sensor and alerts the user as to the opening and closing of the door via a transceiver. Thus, users receive alerts and notifications of package drop off times, and are also alerted to any unauthorized access to the mailbox.

Yet another object of the present invention is to provide an electronic mailbox system comprising a refrigeration unit for maintaining a cool temperature within the mailbox housing, wherein the refrigeration unit is controllable from a remote electronic device, such as a smartphone.

Another object of the present invention is to provide an electronic mailbox system that may be readily fabricated from materials that permit dative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the electronic mailbox system.

FIG. 2 shows a close-up view of the electronic mailbox system.

FIG. 3 shows a cross-sectional view of the electronic mailbox system along line 3-3 of FIG. 1.

FIG. 4 shows a shown a flowchart of the method performed by the electronic mailbox system.

### DETAILED DESCRIPTION OF THE INVENTION

Reference is made herein to the attached drawings. Like reference numerals are used throughout the drawings to depict like or similar elements of the electronic mailbox system. For the purposes of presenting a brief and clear description of the present invention, the preferred embodiment will be discussed as used for receiving mail and packages, and alerting users via transceiver of the delivery. The figures are intended for representative purposes only and should not be considered to be limiting in any respect.

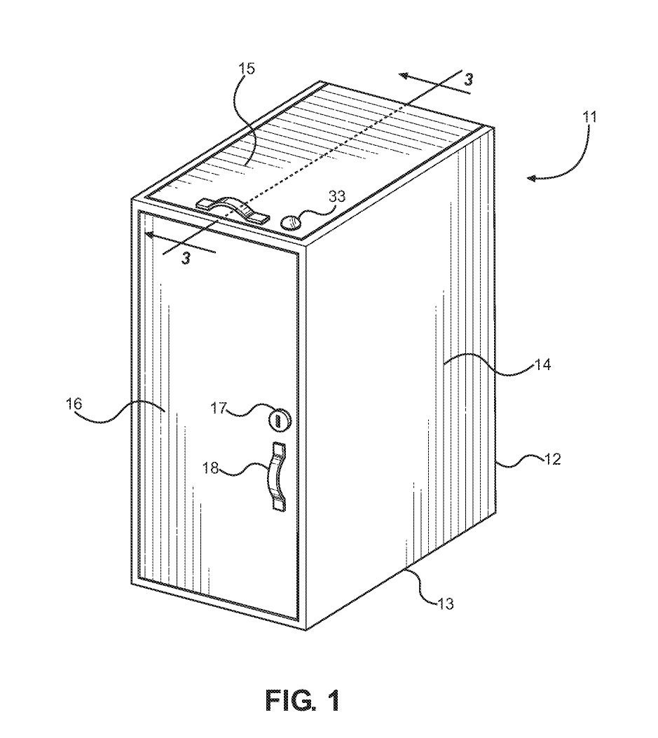

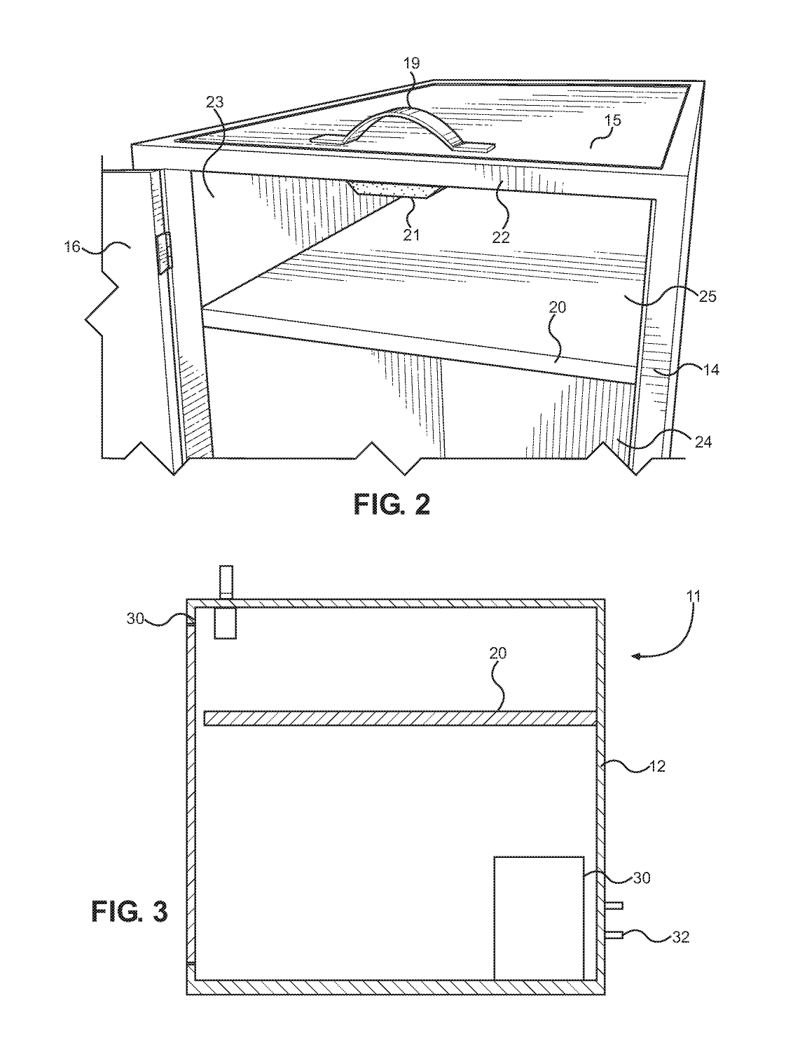

Referring now to FIGS. 1 and 2, there is shown a perspective view of the electronic mailbox system, and a close-up view of the electronic mailbox system, respectfully. The electronic mailbox system 11 provides a device for securely receiving mail and packages, and notifying a user of attempts to access the received mail. The electronic mailbox system 11 comprises a housing 12 having a base 13, one or more sidewalls 14, forming an interior volume 23 configured to hold mail and packages therein. A door 16 is hingedly affixed to a front end 22 of the housing 12, wherein the door 16 is movable between an open configuration and a closed configuration relative to the housing 12. A second door 15 is hingedly affixed to an upper end of the housing 12 a provides access to the interior volume 23 through the upper end. A first handle 18 is disposed on the door 16 and a second handle 19 is disposed on the second door. The handles 18, 19 provide a gripping surface to assist with the moving of the doors 15, 16 between open and closed configurations. In one use, the handles 18, 19 are semicircular rings that can be easily manually gripped by a user. In another embodiment, the handles 18, 19 are configured to interact with a delivery drone.

A locking mechanism 17 is operably connected to the door 16, and the locking mechanism 17 is configured to control access to the interior volume 23 of the housing 12. In one embodiment, the locking mechanism 17 is a conventional lock requiring a key to unlock and lock. In alternative embodiments, the locking mechanism 17 comprises an electronic lock that is controlled by electronic commands. Further, the locking mechanism may be configured to lock both the doors 15, 16.

A shelf 20 is disposed within the interior volume 23. In the shown embodiment, the shelf 20 is parallel to the base 13 and divides the interior volume 23 into a first compartment 24 and a second compartment 25. The first compartment 24 is accessible via the second door 16 and the second compartment 25 is accessible via both the door 16 and the second door 15. The shelf 20 is configured to support packages and mail thereon. In one embodiment the shelf is collapsible or otherwise movable, such that if moved the first compartment 24 is not divided from the second compartment 25.

A sensor 21 is disposed on the housing 12 that is configured to detect motion. In the shown embodiment, the sensor 21 is disposed towards the front end 22 of the housing 12. In a preferred embodiment, the sensor 21 can detect movement of the door 16 relative to the housing 12. In a preferred embodiment, the sensor 21 comprises a mercury switch. In one embodiment, the mercury switch comprises a tube having an amount of mercury therein, wherein a switch opens and closes an electrical circuit when between certain angles. The tilting causes the mercury to close or open the circuit, thus indicating movement. In one embodiment, the sensor 21 is operably connected to an indicating mechanism 33, such as a light or speaker, that is activate the sensor 21 detecting motion. The indicating mechanism 33 may be disposed on the exterior of the housing 12, such that a user can visually or audibly inspect the housing 12.

Referring now to FIG. 3, there is shown a cross-sectional view of the electronic mailbox system along line 3-3 of FIG. 1. In the shown embodiment, the housing 12 comprises a refrigeration unit 30 configured to cool the interior volume 23 thereof. In a preferred embodiment, the refrigeration unit 30 is a compression refrigeration unit utilizing a refrigerant that flows through a compressor, which raises the pressure of the refrigerant, a condenser that condenses the refrigerant into a liquid form and giving off heat, and a fan that transfers the heat outside the housing 12.

The housing 12 further comprises a bracket 32 configured to secure the housing 12 to a fixed surface, such as a pole, a wall, or the ground. In one embodiment, the bracket 32 includes a clip. However, in alternative embodiments, the bracket 32 are other fasteners. In the shown embodiment the bracket is disposed on one of the sidewalls, however in alternative embodiments, the bracket 32 may be disposed on a location of the housing 12.

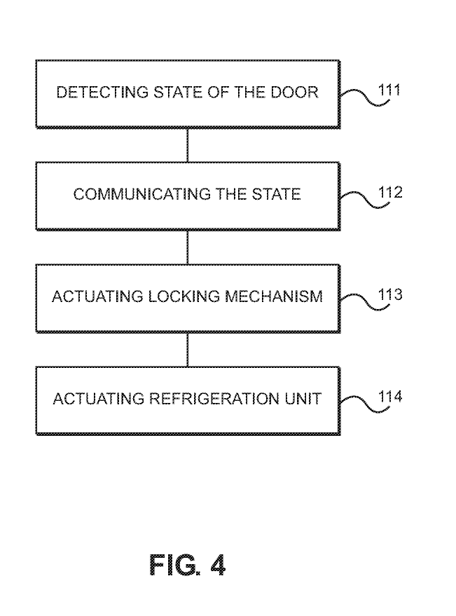

Referring now to FIG. 4, there is shown flowchart of the method performed by the electronic mailbox system. The electronic mailbox system comprises a housing that includes a transceiver, a memory, a processor, a logic stored in the memory that, when executed by the processor, causes the present invention to perform a method, the method comprising the steps of: detecting the door in the open configuration or the closed configuration via a sensor 111, and communicating the open configuration or the closed configuration to a remote electronic device via the transceiver 112. In this way, the electronic mailbox system notifies the remote electronic device of an attempt to open or close the housing door. In another embodiment, the method further comprises actuating the locking mechanism to unlock or lock the door relative to the housing 113 and actuating the refrigeration unit to regulate a temperature of the interior volume of the housing 114.

In an exemplary use of one embodiment the electronic mailbox system, a user is expecting a perishable package to be delivered to the user's place of residence at a time when the user will not be able to personally receive the package. The user unlocks the locking mechanism of the housing and activates the refrigeration unit by pressing a button on a remote electronic device, causing the command to be sent from the remote electronic device and received by the housing via a transceiver. Once the package is delivered to the now unlocked and cooled housing, the sensor of the housing causes a message to be sent to the remote electronic device indicating delivery of the package. Upon delivery, the locking mechanism may remain unlocked or be locked by a timing mechanism or by a command received from the remote electronic device. In this way, a perishable package is securely delivered to a recipient.

It is therefore submitted that the instant invention as been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An electronic mailbox system comprising:
a housing including an interior volume, the interior volume configured to hold packages therein;
a door affixed to the housing, the door movable between an open configuration and a closed configuration relative to the housing;
locking mechanism operably connected to the door, wherein the locking mechanism is configured to control access to the interior volume of the housing; and
a sensor configured to detect motion of the door.

2) The electronic mailbox system of claim 1, further comprising a refrigeration unit configured to cool the interior volume of the housing.

3) The electronic mailbox system of claim 1, wherein the sensor comprises a mercury switch.

4) The electronic mailbox system of claim 1 further comprising:
a shelf dividing the interior volume of the housing into a first compartment and a second compartment.

5) The electronic mailbox system of claim 1 further comprising:
a first door affixed to a front end of the housing, the first door providing access to a first compartment;
a second door affixed to an upper end of the housing, the second door providing access to a second compartment.

6) The electronic mailbox system of claim 1, further comprising an indicating mechanism operably connected to the sensor, wherein the indicating mechanism is actuated by the sensor detecting motion.

7) The electronic mailbox system of claim 1, wherein the housing includes a transceiver, memory, a processor, a logic stored in the memory that, when executed by the processor, causes the electronic device to perform a method, the method comprising:
detecting if the door is in the open configuration or the closed configuration;
communicating the open configuration or the closed configuration to a remote electronic device via the transceiver.

8) The electronic mailbox system of claim 7, further comprising:
actuating the locking mechanism to unlock or lock the door relative to the housing.

9) The electronic mailbox system of claim 8, further comprising:
actuating a refrigeration unit to regulate a temperature of the interior volume of the housing.
